(19) United States
(12) Patent Application Publication
(10) Pub. No.: US 2012/0158252 A1
(43) Pub. Date: Jun. 21, 2012

(54) MOTOR VEHICLE

(75) Inventor: Frank BONARENS, Oberursel (DE)

(73) Assignee: GM GLOBAL TECHNOLOGY OPERATIONS LLC, Detroit, MI (US)

(21) Appl. No.: 13/327,817

(22) Filed: Dec. 16, 2011

(30) Foreign Application Priority Data
Dec. 18, 2010 (DE) 102010055130.9

(51) Int. Cl. G06F 17/00

(52) U.S. Cl. 701/49; 701/36

(57) ABSTRACT

A motor vehicle includes, but is not limited to a manual transmission and at least one control unit that is configured to determine and indicate to a driver in a haptically perceptible manner a time for a fuel consumption-favorable gear change in that it induces vibration in a footrest.

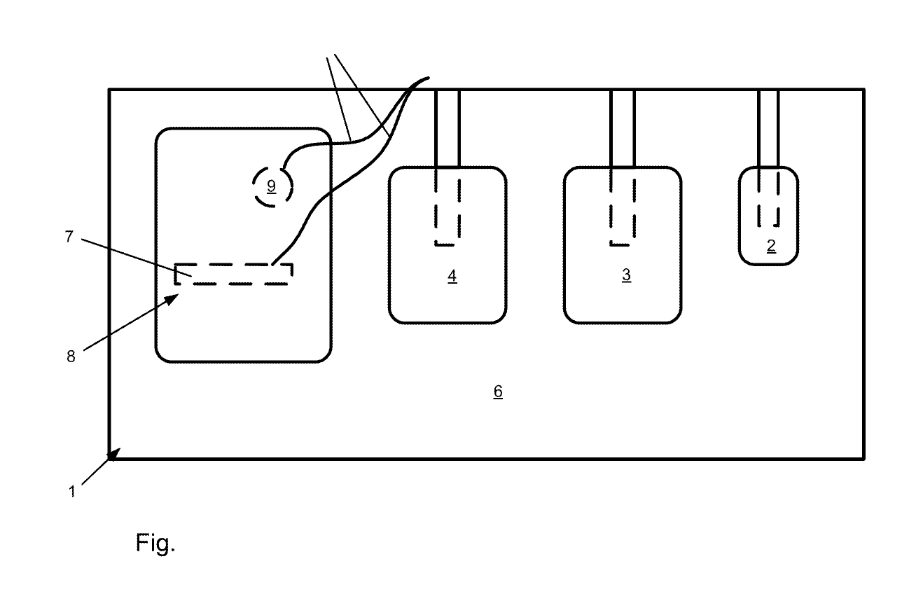

### CROSS-REFERENCE TO RELATED APPLICATION

This application claims priority to German Patent Application No. 102010055130.9, filed Dec. 18, 2010, which is incorporated herein by reference in its entirety.

### TECHNICAL FIELD

The technical field relates to a motor vehicle with a driver assistance system, a manual transmission and at least one control unit.

### BACKGROUND

EP 0 906 845 B1 discloses a method for the activation of a drive system of a motor vehicle as a function of information regarding a current driving situation and one that is expected, which information is captured via vehicle-internal and vehicle-external information sources in an electronic motor vehicle system. Dependent on this information, a driving information setpoint strategy is determined, and the driver through an actuation force increase of an accelerator pedal receives a haptically perceptible feedback when the position of the accelerator pedal suggested by the driving operation setpoint strategy is exceeded.

In view of the foregoing, it is desirable to provide a motor vehicle is to be configured that it supports a driver in his driving style and also has a simple and reliable construction. In addition, other desirable features and characteristics will become apparent from the subsequent summary and detailed description, and the appended claims, taken in conjunction with the accompanying drawings and this background.

### SUMMARY

A motor vehicle comprises a driver assistance system, a manual transmission and at least one control unit which displays information for a driver in a haptically perceptible manner in that it induces vibration in a footrest. The driver assistance system can draw attention through a vibration of the footrest for example to driving through a curve with too high a driving speed, a impairment of visions, for example, through fog, an instance of exceeding a speed limit or the like and the driver of the motor vehicle can initiate suitable measures. It is likewise possible that the driver assistance system detects the onset of tiredness of the driver, particularly by way of the eye movements, and induces vibration in the footplate. Suitable sensors for monitoring the vehicle surroundings, the vehicle interior and the vehicle itself are assigned to the driver assistance system, are known to the person skilled in the art from the prior art.

In a configuration, the driver assistance system determines a time for a gear change that is favorable for the fuel consumption and indicates this to the driver in a haptically perceptible manner in that it induces vibration in the footrest. The footrest, which is employed is present on the side of a clutch pedal facing away from an accelerator pedal. Accordingly, through the vibration, which can have any oscillations, the driver receives haptically perceptible information on the foot with which he is to next undertake something, i.e., for example actuate the clutch pedal in order to subsequently carry out a gear change. In that vibration is induced in the footrest, risks, which can occur through a function impairment of a pedal because of the assignment of a corresponding device, are excluded. In particular, the vibration cannot result in a blocking of a pedal.

Practically, an actuator is assigned to the plate-shaped footrest arranged in the footwell next to a clutch pedal. The preferentially electronic actuator is in connection with the control unit and induces vibrations in the footrest when the control unit sends a corresponding signal, which is caused because of the possibility of a more economical driving style through a gear change, i.e., the shifting into a lower or higher gear. In the control unit, in which a multiplicity of trip-dependent information is present and processed appropriate rules known to the person skilled in the art are stored which allow determining the most favorable gear or the most economical driving stage with the existing conditions, i.e., in particular speed, engine rotational speed and/or actual consumption. If the most favorable gear by calculation does not coincide with the engaged gear, the actuator is activated in order to put the footrest in motion and by doing so indicate a change to the driver. In the region of the footrest next to the pedals adequate package space is available as a rule or relatively thick insulation mats are available in order to integrate the actuator.

So as to avoid that the actuator has to work against the force exerted by the foot the actuator advantageously moves the footrest in a direction that runs transversely to the main step-on direction. The movement direction of the footrest corresponds to an x, y-plane substantially defined perpendicularly to a z-direction. The footrest need not be moved linearly in a space direction but can be moved along a curved path, wherein the vibration is then generated substantially parallel to the footrest on which the foot of the driver is placed. Here, the footrest can vibrate both only in one first direction as well as in two or a plurality of further directions in order to transmit for example different information to the driver.

In an embodiment, the actuator is an electromagnet acting between a floor panel and the footrest. Through a targeted activation, appropriate lift shocks can be generated and thus forces transmitted to the footrest, which is preferentially mounted in a floating manner to a floor panel of the motor vehicle. Alternatively, the actuator is designed as a piezo element or comprises a mass that can be moved via an electric motor. Preferably, the vibration is variable with respect to frequency and/or amplitude. It is thus possible for example to transmit an urgency of the changing to the driver.

According to an embodiment, the footrest is assigned a switch which switches the actuator on and off. Practically, the switch is a push-button switch that can be pressed by actuating the footrest. Should the driver do not wish any assistance in conducting the motor vehicle with respect to a fuel-saving driving style he can switch off the actuator by means of the foot-actuated switch. In order for the driver to be visually informed regarding the switching state of the switch, a display for the switching state of the switch is arranged in an instrument.

It is to be understood that the features mentioned above and still to be explained in the following cannot only be used in the respective combination stated but also in other combinations. The scope is only defined by the claims.

### BRIEF DESCRIPTION OF THE DRAWINGS

The present invention will hereinafter be described in conjunction with the following drawing figure that shows a schematic representation of a footwell on the driver's side of a motor vehicle.

### DETAILED DESCRIPTION OF THE EXEMPLARY EMBODIMENT

The following detailed description is merely exemplary in nature and is not intended to limit application and uses. Furthermore, there is no intention to be bound by any theory presented in the preceding background or summary or the following detailed description.

In its footwell 1 on the driver side the vehicle comprises arranged next to one another an accelerator pedal 2, a brake pedal 3 and a clutch pedal 4. In the free space next to the clutch pedal 4 on the side located opposite the accelerator pedal 2 a plate-shaped footrest 5 is moveably mounted on a floor panel 6. Between the footrest and the floor panel 6 an actuator 8 designed as electromagnet 7 and an electric switch 9 are arranged, which are connected to a control unit of the motor vehicle via lines 10.

If the control unit determines a current driving state with which a fuel-saving driving style is possible through a gear change, it activates the electromagnet 7 so that the latter induces vibration in the footrest 5 in order to draw the attention of the driver to this fact. The electromagnet 7 moves the footrest 5 in a direction running transversely to the main step-on direction and the vibrations are variable with regard to their frequency and/or amplitude in order to communicate to the driver an urgency of the change.

Should the driver wish not to be alerted to a practical gear change he can switch off the actuator 8 in that he actuates the switch 9 assigned to the footrest 5, wherein the switching state can be visually perceived by a visual display device.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
a driver assistance system;
a manual transmission;
a footrest; and
a control unit that is configured to display information for a driver in a haptically perceptible manner that induces vibration in the footrest.

2. The motor vehicle according to claim 1, wherein the driver assistance system is configured to determine a time for a fuel consumption-favorable gear change and further configured to display the time to the driver in the haptically perceptible manner in that induces the vibration in the footrest.

3. The motor vehicle according to claim 1, wherein the footrest is a plate-shaped footrest arranged in a footwell next to a clutch pedal that is assigned an actuator.

4. The motor vehicle according to claim 3, wherein the actuator is configured to move the footrest in a direction running transversely to a main step-on direction.

5. The motor vehicle according to claim 4, wherein the actuator is an electromagnet acting between a floor panel and the footrest.

6. The motor vehicle according to claim 4, wherein the actuator is a piezo element.

7. The motor vehicle according to claim 4, wherein the actuator comprises a mass that is configured to move via an electric motor.

8. The motor vehicle according to claim 1, wherein the vibrations are variable vibrations with respect to frequency.

9. The motor vehicle according to claim 1, wherein the vibrations are variable vibrations with respect to amplitude.

10. The motor vehicle according to claim 1, wherein the footrest is assigned a switch that is configured to switch the actuator on and off.

11. The motor vehicle according to claim 10, wherein the switch is a push-button switch that is configured to be pressed through actuation of the footrest.

12. The motor vehicle according to claim 10, further comprising:
an instrument panel; and
a display that is configured to switch a switching state of the switch , the display arranged in an instrument.
